(19) United States
(12) Patent Application Publication
(10) Pub. No.: US 2014/0322564 A1
(43) Pub. Date: Oct. 30, 2014

(54) BATTERY WITH INERT ELECTRODES AND METHOD FOR GENERATING ELECTRICAL POWER USING THE SAME

(71) Applicant: TAIWAN HOPAX CHEMICALS MFG. CO., LTD., Kaohsiung City (TW)

(72) Inventors: Yung-Han HUANG, Taipei City (TW); Pei-Jung HUANG, Taipei City (TW); Chien-Ho HUANG, Taipei City (TW); Tsung-Tien KUO, Kaohsiung City (TW)

(21) Appl. No.: 14/330,650

(22) Filed: Jul. 14, 2014

Related U.S. Application Data
(63) Continuation-in-part of application No. 12/912,455, filed on Oct. 26, 2010.

(30) Foreign Application Priority Data
Oct. 28, 2009 (TW) 098136413

(51) Int. Cl. H01M 6/34; H01M 4/38

(52) U.S. Cl. CPC H01M 6/34; H01M 4/38; H01M 2300/0002
USPC 429/50; 429/119

(57) ABSTRACT

A battery includes: a container; an electrolyte received in the container; and first and second electrodes disposed in the electrolyte and having different electrical potentials upon exposure to the electrolyte.

### CROSS-REFERENCE TO RELATED APPLICATION

This application is a continuation in part application of U.S. patent application Ser. No. 12/912,455, filed Oct. 26, 2010 and claiming priority of Taiwanese application no. 098136413, filed on Oct. 28, 2009.

### BACKGROUND OF THE INVENTION

1. Field of the Invention

The invention relates to a battery and a method for generating electrical power using the battery, more particularly to a battery including electrodes inert to an electrolyte of the battery.

2. Description of the Related Art

U.S. Pat. No. 2,921,110 discloses a battery cell that includes an electrode having a member selected from the group consisting of alkali and alkaline earth metals, a porous electrically conductive electrode, a molten electrolyte including sodium hydroxide, means for passing the molten electrolyte through the cell at a controlled rate and means for passing an oxidizing agent into effective proximity with the electrolyte through the porous electrically conductive electrode. U.S. Pat. No. 3,386,859 discloses an electrochemically reactive porous electrode that includes a body of electrically conductive substrate adhered with a layer that has catalyst particles, a fluorocarbon resin-containing hydrophobic binder and a filler of asbestos fibers to form fluid-conducting paths coextensive with the body. These two U.S. patents both disclose a fuel cell that involves utilizing an aqueous alkaline solution as the electrolyte to serve as an electrochemical connection between the oxidant and fuel electrodes, continuously introducing an oxidant at the oxidant electrode (cathode) where it contacts the electrolyte and forms ions, and continuously introducing a reductant at the fuel electrode (anode) where it forms ions and leaves the anode negatively charged. The conventional fuel batteries produce electricity continuously as long as the fuel and the oxidizing agent are supplied.

U.S. Pat. No. 3,607,428 discloses a conventional seawater battery that uses a mechanical mechanism to successively raise a water level of seawater in a container for contacting a magnesium electrode. Thus, with each successive cycle, some magnesium of the magnesium electrode will be eroded from the bottom. When the magnesium of the electrode is completely consumed, the battery life ends.

There is still a need in the art to provide a permanent battery without consuming earth resources and causing environmental pollution.

### SUMMARY OF THE INVENTION

The object of the present invention is to provide a battery including electrodes that are not consumable so that the battery life can be permanently extended without replacement of the electrodes.

According to one of the aspect of the present invention, there is provided a battery that comprises: a container; an electrolyte received in the container; and first and second electrodes disposed in the electrolyte and having different electrical potentials upon exposure to the electrolyte. The first and second electrodes are inert to the electrolyte. One of the first and second electrodes is made from a sintered metal powder.

According to another aspect of the present invention, there is provided a battery that comprises: a container; an electrolyte received in the container; and first and second electrodes disposed in the electrolyte and having different electrical potentials upon exposure to the electrolyte. The first and second electrodes are inert to the electrolyte. The electrical potential difference between the first and second electrodes is greater than 450 mV.

According to yet another aspect of the present invention, there is provided a method for generating electrical power. The method comprises: preparing first and second electrodes that are inert to an electrolyte and that have different electrical potentials upon exposure to the electrolyte; placing the first and second electrodes in the electrolyte in a container for producing an output voltage through spontaneous reduction and oxidation of the composition of the electrolyte at the first and second electrodes, respectively, without consuming the first and second electrodes; and supplying a fresh electrolyte into the container and discharging the used electrolyte from the container so as to maintain substantially the composition of the electrolyte in the container for continuing the production of the output voltage.

### BRIEF DESCRIPTION OF THE DRAWINGS

In drawings which illustrate an embodiment of the invention,

FIG. 1 is a schematic view of the preferred embodiment of a battery according to this invention; and

FIG. 2 is a plot of an output current versus an electrical potential difference between two electrodes of the preferred embodiment for Examples 1-6 of this invention.

### DETAILED DESCRIPTION OF THE PREFERRED EMBODIMENT

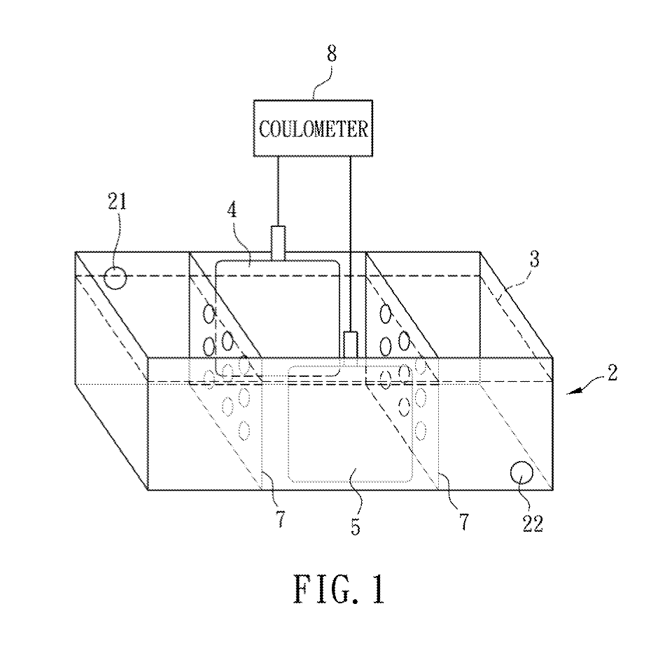

Referring to FIG. 1, the battery of the preferred embodiment according to the present invention includes: a container 2; two filter plates 7 disposed in the container 2 to divide the container 2 into three compartments; an electrolyte 3 received in the container 2; and first and second electrodes 4, 5 disposed in the electrolyte 3 and having different electrical potentials upon exposure to the electrolyte 3. The electrical potential of each of the first and second electrodes 4, 5 is measured using a standard calomel electrode as a reference electrode. The first and second electrodes 4, 5 are inert to the electrolyte 3, i.e., they are not consumable in the process of producing an output voltage. The container 2 has an inlet 21 for entrance of a fresh electrolyte 3 into the container 2, and a drainage outlet 22 for discharge of a used electrolyte 3 from the container 2. A coulometer 8 can be connected to the first and second electrodes 4, 5 for measuring the current generated by the battery.

Preferably, the electrical potential difference between the first and second electrodes 4, 5 is greater than 450 mV. More preferably, the electrical potential difference between the first and second electrodes 4, 5 ranges from 480 mV to 1.5V, and even more preferably, from 677 mV to 1.2V.

In one embodiment, the first and second electrodes 4, 5 are respectively made from an inert material selected from the group consisting of platinum (Pt), titanium (Ti) and tantalum (Ta).

In another embodiment, one of the first and second electrodes 4, 5 is made from a sintered metal powder and the other of the first and second electrodes 4, 5 is made from a bimetallic material that has a first metal coated with a second metal different from the first metal.

Alternatively, surfaces of the first and second electrodes may be roughened so as to increase the potential difference therebetween.

The metal powder and the first and second metals used for making the first and second electrodes 4, 5 may be obtained from a natural source or a recycled source.

Non-limiting examples of the first metal can be selected from Ta and Ti. Non-limiting examples of the second metal can be selected from platinum (Pt), cladding Pt and Pt black.

In one embodiment, the sintered metal powder is made from a metal selected from tantalum (Ta), niobium (Nb) and titanium (Ti).

Non-limiting examples of the electrolyte 3 may be seawater or industrial waste waters that have been treated and that have salts, such as sodium sulphate, dissolved therein in a constant composition. In one embodiment, the electrolyte 3 is seawater.

The method of generating electrical power using seawater as the electrolyte 3 includes placing the first and second electrodes 4, 5 in the seawater in the container 2 for producing an output voltage through spontaneous reduction and oxidation of the composition of the seawater at the first and second electrodes 4, 5, respectively, without consuming the first and second electrodes 4, 5; and supplying a fresh seawater into the container 2 and discharging the used seawater from the container 2 so as to maintain substantially the composition of the seawater in the container 2 for continuing with the production of the output voltage. Particularly, in one of the first and second electrodes 4, 5, which serves as the cathode, the reduction reaction of the following chemical equation occurs:

2H₂O+2e⁻→H₂+2OH⁻.

In the other of the first and second electrodes 4, 5, which serves as the anode, the oxidization reactions of the following chemical equations occur:

2H₂O→4e⁻+4H⁺, +O₂;

and

2Cl⁻→2e⁻+Cl₂.

The following Examples are provided to illustrate the merits of the preferred embodiment of the invention, and should not be construed as limiting the scope of the invention.

### Example 1

A body of seawater (30° C.) was added into a container to fill the container to a predetermined level. A continuous seawater flow (30° C.) was subsequently provided to flow through the container. Two platinum (Pt) electrode plates (2 cm×2 cm and 5 cm×8 cm) having electrical potentials of 470.1 mV and 479.9 mV (a difference of 9.8 mV), respectively, were immersed in the seawater in the container to form the battery. The battery was then connected in series to a coulometer used for measuring an output current generated by the battery. A steady current of 0.05 μA was measured.

### Example 2

A body of seawater (30° C.) was added into a container to fill the container to a predetermined level. A continuous seawater flow (30° C.) was subsequently provided to flow through the container. A titanium (Ti) electrode plate (5 cm×7.5 cm) and a tantalum (Ta) electrode plate (5 cm×7.5 cm) having electrical potentials of 386.8 mV and 319.8 mV (a difference of 67 mV), respectively, were immersed in the seawater in the container to form the battery. The battery was then connected in series to a coulometer used for measuring an output current generated by the battery. A steady current of 15 μA was measured.

### Example 3

A body of seawater (30° C.) was added into a container to fill the container to a predetermined level. A continuous seawater flow (30° C.) was subsequently provided to flow through the container. A platinum (Pt) electrode plate (5 cm×8 cm) and a titanium (Ti) electrode plate (3 cm×5 cm) having electrical potentials of 479.9 mV and 386.8 mV (a difference of 93.1 mV), respectively, were immersed in the seawater in the container to form the battery. The battery was then connected to a coulometer used for measuring an output current generated by the battery. A steady current of 50 μA was measured.

### Example 4

A body of seawater (30° C.) was added into a container to fill the container to a predetermined level. A continuous seawater flow (30° C.) was subsequently provided to flow through the container. A platinum (Pt) electrode plate (5 cm×8 cm) and a tantalum (Ta) electrode plate (2.4 cm×5 cm) having electrical potentials of 479.9 mV and 319.8 mV (a difference of 160.1 mV), respectively, were immersed in the seawater in the container to form the battery. The battery was then connected to a coulometer used for measuring an output current generated by the battery. A steady current of 0.12 mA was measured.

### Example 5

A body of seawater (30° C.) was added into a container to fill the container to a predetermined level. A continuous seawater flow (30° C.) was subsequently provided to flow through the container. A platinum-clad titanium electrode plate (5.5 cm×6 cm) and a tantalum (Ta) electrode plate (2.4 cm×5 cm) having electrical potentials of 804.8 mV and 319.8 mV (a difference of 485 mV), respectively, were immersed in the seawater in the container to form the battery. The battery is then connected to a coulometer used for measuring an output current generated by the battery. A steady current of 0.35 mA was measured.

### Example 6

A body of seawater (30° C.) was added into a container to fill the container to a predetermined level. A continuous seawater flow (30° C.) was subsequently provided to flow through the container. A platinum-clad titanium electrode plate (5.5 cm×6 cm) and a porous sintered tantalum (Ta) electrode (containing 3 ta pellets made from recycled chip tantalum capacitors, the size of each being 3.4 mm×3.4 mm×1.9 mm) having electrical potentials of 804.8 mV and 127.2 mV (a difference of 677.6 mV), respectively, were immersed in the seawater in the container to form the battery. The battery was then connected to a coulometer used for measuring an output current generated by the battery. A steady current of 1.7 mA was measured.

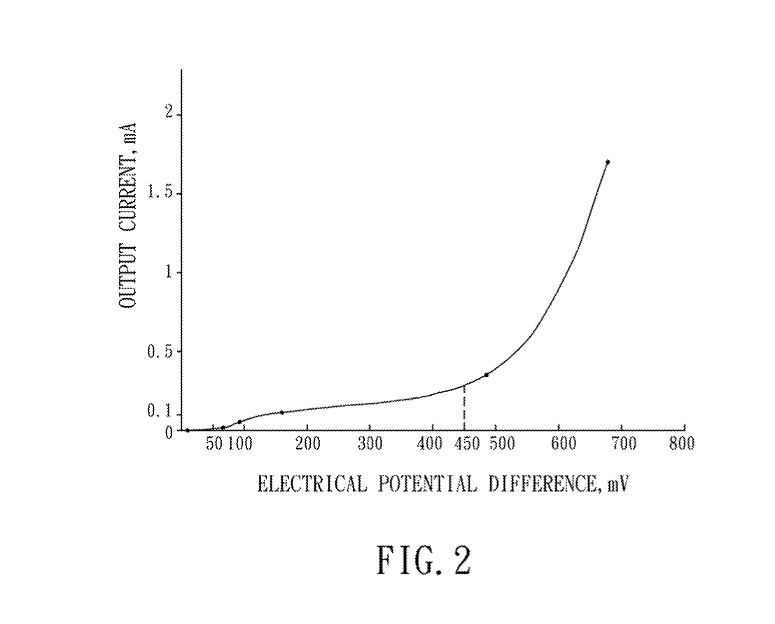

FIG. 2 shows that the preferred embodiment of this invention exhibits a sharp increase in the output current when the electrical potential difference between the first and second electrodes 4, 5 is greater than about 450 mV. Based on the results obtained from the non-limiting Examples 1 to 6, the electrical potential difference between the first and second electrodes 4, 5 shown in FIG. 2 is up to about 677 mV. However, per the inventors' understanding and experiences, the electrical potential difference between the first and second electrodes 4, 5 of the present invention is able to increase to about 1.2V, and even to about 1.5V.

By enlarging the electrical potential difference between the electrolyte-inert first and second electrodes 4, 5 of the battery of this invention, a permanent battery without consuming the electrodes can be achieved. Besides, by increasing the electrical potential difference between the electrolyte-inert first and second electrodes 4, 5, and by increasing the specific surface area of the electrolyte-inert first and second electrodes 4, 5, the steady current is obtained without any additional applied voltage.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A battery comprising:
a container;
an electrolyte received in said container; and
first and second electrodes disposed in said electrolyte and having different electrical potentials upon exposure to said electrolyte, said first and second electrodes being inert to said electrolyte;
wherein one of said first and second electrodes is made from a sintered metal powder.

2. The battery of claim 1, wherein the other of said first and second electrodes is made from a bimetallic material that has a first metal coated with a second metal different from the first metal.

3. The battery of claim 2, wherein said second metal is selected from platinum (Pt), cladding Pt and Pt black.

4. The battery of claim 2, wherein said first metal is selected from tantalum (Ta) and titanium (Ti).

5. The battery of claim 1, wherein said sintered powder is made from a metal selected from Ta, niobium (Nb) and Ti.

6. The battery of claim 1, wherein said electrolyte is seawater.

7. A battery comprising:
a container;
an electrolyte received in said container; and
first and second electrodes disposed in said electrolyte and having different electrical potentials upon exposure to said electrolyte, said first and second electrodes being inert to said electrolyte;
wherein the electrical potential difference between said first and second electrodes is greater than 450 mV.

8. The battery of claim 7, wherein one of said first and second electrodes is made from a sintered metal powder.

9. The battery of claim 8, wherein the other of said first and second electrodes is made from a bimetallic material that has a first metal coated with a second metal different from the first metal.

10. The battery of claim 7, wherein said first and second electrodes are respectively made from an inert material selected from the group consisting of platinum (Pt), titanium (Ti), and tantalum (Ta).

11. The battery of claim 7, wherein said electrolyte is seawater.

12. The battery of claim 7, wherein the electrical potential difference between said first end second electrodes ranges from 480 mV to 1.5V.

13. The battery of claim 7, wherein the electrical potential difference between said first and second electrodes ranges from 677 mV to 1.5V.

14. A method for generating electrical power, comprising:
preparing first and second electrodes that are inert to an electrolyte and that have different electrical potentials upon exposure to the electrolyte;
placing the first and second electrodes in the electrolyte in a container for producing an output voltage through spontaneous reduction and oxidation of the composition of the electrolyte at the first and second electrodes, respectively, without consuming the first and second electrodes; and
supplying a fresh electrolyte into the container and discharging the used electrolyte from the container so as to maintain substantially the composition of the electrolyte in the container for continuing the production of the output voltage.

15. The method of claim 14, wherein the electrical potential difference between the first and second electrodes is greater than 450 mV.

16. The method of claim 14, wherein the electrical potential difference between the first and second electrodes ranges from 480 mV to 1.5V.

17. The method of claim 14, wherein the electrical potential difference between the first and second electrodes ranges from 677 mV to 1.5V.

18. The method of claim 14, wherein one of the first and second electrodes is made from a sintered metal powder.

19. The method of claim 18, wherein the other of the first and second electrodes is made from a bimetal lie material that has a first metal coated with a second metal different from the first metal.

20. The method of claim 14, wherein the electrolyte is seawater.
